(19) United States
(12) Patent Application Publication
(10) Pub. No.: US 2026/0362197 A1
(43) Pub. Date: Nov. 12, 2026

(54) REMOTE INTERFERENCE MANAGEMENT REFERENCE SIGNAL PROCESSING IN A RADIO UNIT

(71) Applicant: QUALCOMM Incorporated, San Diego, CA (US)

(72) Inventors: Abhishek Saurabh SACHIDANAND SINHA, San Diego, CA (US); Chiranjib SAHA, Lakeside, CA (US); Andrei Dragos RADULESCU, La Jolla, CA (US); Rajat PRAKASH, San Diego, CA (US); Xiaoxia ZHANG, San Diego, CA (US); Mostafa KHOSHNEVISAN, San Diego, CA (US)

(21) Appl. No.: 19/202,669

(22) Filed: May 8, 2025

(51) Int. Cl. H04W 24/10; H04W 8/22; H04W 24/08; H04W 52/02

(52) U.S. Cl. CPC H04W 24/10; H04W 8/22; H04W 24/08; H04W 52/0235

(57) ABSTRACT

Certain aspects of the present disclosure provide techniques for wireless communications. An example method includes transmitting, to a distributed unit, an indication of a capability to support a remote interference management reference signal (RIM-RS) measurement; obtaining, from the distributed unit, a first configuration related to the RIM-RS measurement and a second configuration related to an RIM-RS measurement report; performing the RIM-RS measurement in accordance with the first configuration; and transmitting, to the distributed unit, the RIM-RS measurement report in accordance with the second configuration.

### INTRODUCTION

### Field of the Disclosure

Aspects of the present disclosure relate to wireless communications, and more particularly, to techniques for handling remote interference management reference signal (RIM-RS)-related processing in a radio unit.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects provide a method for wireless communications by a radio unit. The method includes transmitting, to a distributed unit, an indication of a capability to support a remote interference management reference signal (RIM-RS) measurement; obtaining, from the distributed unit, a first configuration related to the RIM-RS measurement and a second configuration related to an RIM-RS measurement report; performing the RIM-RS measurement in accordance with the first configuration; and transmitting, to the distributed unit, the RIM-RS measurement report in accordance with the second configuration.

Certain aspects provide a method for wireless communications by a distributed unit. The method includes obtaining, from a radio unit, an indication of a capability to support a RIM-RS measurement; transmitting, to the radio unit, a first configuration related to the RIM-RS measurement and a second configuration related to an RIM-RS measurement report; and obtaining, from the radio unit, the RIM-RS measurement report in accordance with the second configuration, the RIM-RS measurement report based on the RIM-RS measurement performed in accordance with the first configuration.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5 depicts an illustration of a remote interference in a wireless communications network.

FIG. 6 depicts an example of a remote interference in a wireless communications network.

FIG. 7 depicts an illustration of a remote interference in a wireless communications network.

FIG. 8 depicts a process flow for communications in a network between a radio unit and a distributed unit.

FIG. 9 depicts another process flow for communications in a network between a radio unit and a distributed unit.

FIG. 10 depicts a method for wireless communications.

FIG. 11 depicts another method for wireless communications.

FIG. 12 depicts aspects of an example communications device.

FIG. 13 depicts aspects of an example communications device.

### DETAILED DESCRIPTION

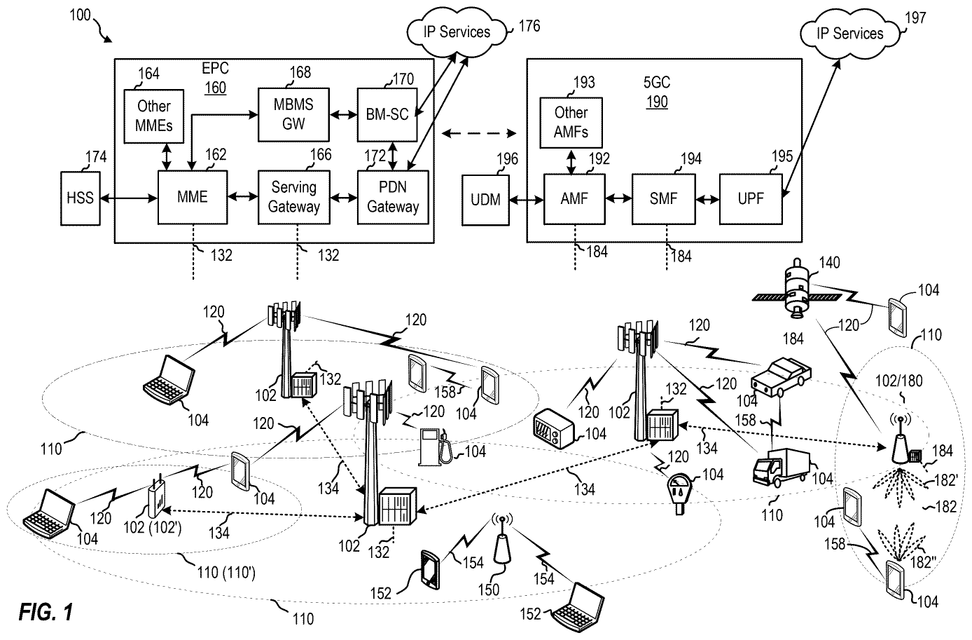

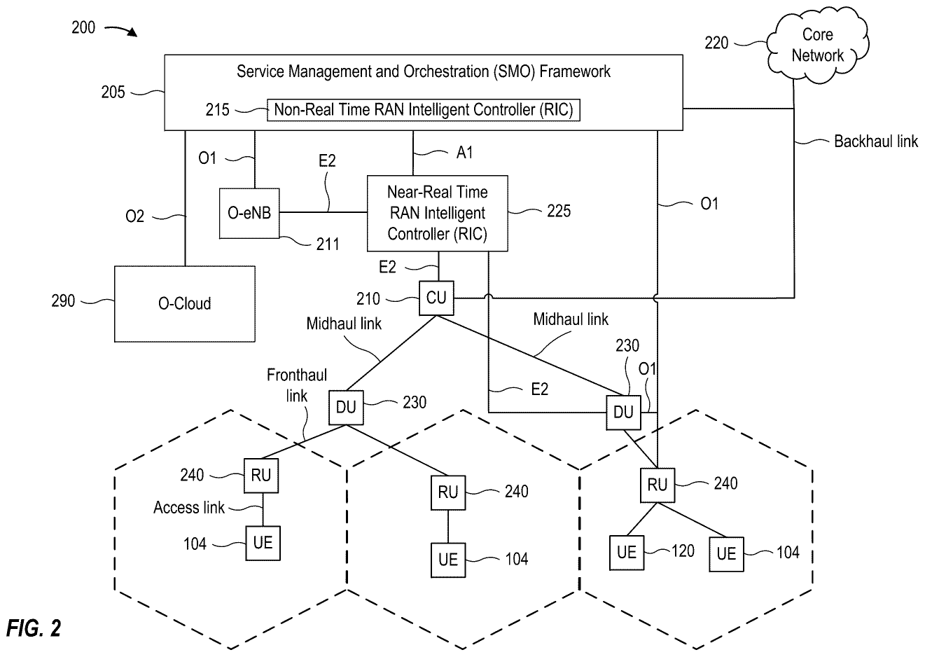

Aspects of the present disclosure provide apparatuses, methods, processing systems, and computer-readable mediums for handling remote interference management reference signal (RIM-RS)-related processing in a radio unit. The radio unit as well as a distributed unit described herein may be part of a base station in wireless communications systems, as described herein with reference to, for example, FIGS. 1 and 2.

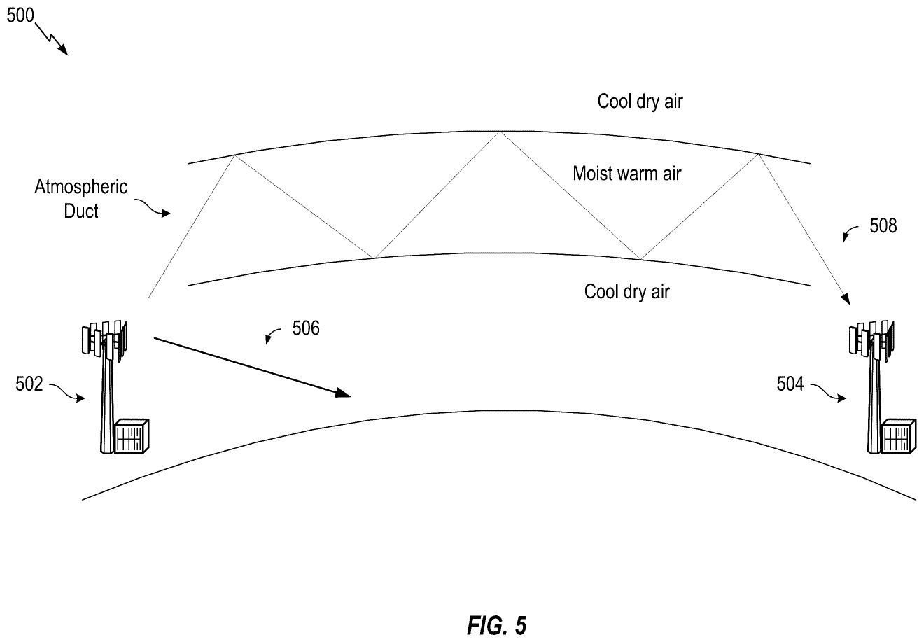

In certain wireless communications systems, such as 5G New Radio (NR) systems and/or future wireless communications technologies, a remote interference refers to an interference caused at a “victim” network entity (e.g., a base station such as a next generation NodeB (gNB or gNodeB)—also may be referred to as a victim cell) by an “aggressor” network entity (e.g., another base station such as another gNB—also may be referred to as an aggressor cell). For example, downlink communications at the aggressor network entity may cause the interference with uplink communications at the victim network entity. In certain cases, the aggressor network entity and the victim network entity may be located far apart (e.g., 150-400 kilometers (km)). Thus, this interference is referred to as remote interference. Additional details regarding the remote interference are described herein with reference to FIGS. 5-7.

A RIM-RS refers to a reference signal that is used to aid in detecting and mitigating the remote interference. There are two types of RIM-RSs: Type-1 and Type-2. Type-1 RIM-RS is transmitted by a victim cell, intended to be received by aggressor cell(s). Type-1 RIM-RS from the victim cell is used to signal that a remote interference is present at the victim cell (e.g., that a ducting phenomenon, described herein with reference to FIG. 5, exists). Type-1 RIM-RS may convey information including, for example, an identity of the cell(s) (e.g., the group(s) of cell(s)) that is causing the interference, as well as a number of orthogonal frequency division multiplexing (OFDM) symbols at the beginning of an uplink period that is affected by the remote interference. For example, such information (e.g., the number of OFDM symbols at the beginning of the uplink period that is affected by the remote interference) may be useful for determining by how much a guard period may be increased to mitigate the remote interference. This is one example of a remote interference management (RIM) technique. Type-1 RIM-RS may also convey information about whether the amount of mitigation which may be applied by the aggressor cell is sufficient or not (e.g., from the perspective of the victim cell). Type-2 RIM-RS is transmitted by the aggressor cell and is used to indicate that a ducting phenomenon exists. Unlike Type-1 RIM-RS, Type-2 RIM-RS does not convey any other information than the indication of the ducting phenomenon.

Reference signal resource for the RIM-RS may include a cyclic prefix (CP) and 2 symbols. Moreover, the RIM-RS may use a Gold sequence with a length of 2³¹-1, where the Gold sequence may include a pseudorandom sequence that meets the requirements of a well-focused autocorrelation, ensuring a consistent channel estimation quality across different frequencies. This sequence may be generated across all common resource blocks (CRBs) and is transmitted (e.g., only) where data is being transmitted, optimizing resource usage. An identifying parameter in the RIM-RS may include a 10-bit scrambling identifier (SCID), and other parameters may include a multiplier and an offset (e.g., for randomness). For example, the key identifying parameter in the RIM-RS may include a frequency offset, a timing offset, and an SCID. Another parameter may include a RIM-RS bandwidth, where an actual bandwidth may be expressed in a number of resource blocks (RBs) (e.g., 48, 96, etc.). For example, if a subcarrier spacing (SCS) is 15 kHz, the RIM-RS bandwidth may be a minimum of 20 MHz and a carrier bandwidth. If an SCS is 30 kHz, the RIM-RS bandwidth may be 40 MHz or a minimum of 20 MHz and a carrier bandwidth.

In certain cases, RIM-RS processing based on a RIM-RS configuration may be performed in a distributed unit. Certain technical problems and/or challenges may exist when the RIM-RS processing is performed in the distributed unit.

One technical challenge may be related to time and frequency periodicity. For example, it may be possible or supported to configure at most 32 RIM-RS resources within 10 milliseconds (ms). In the time domain, each RIM-RS resource may span two consecutive OFDM symbols. In the frequency domain, for a 15-kHz SCS, it may be possible to configure 4 blocks, each spanning 96 physical resource blocks (PRBs), which implies an entire carrier. Moreover, the technical challenge may be related to spatial sampling resolution. For example, a RIM-RS optimal discovery by a victim cell may utilize a sampling of all available receive antenna elements. These factors may result in a sudden surge in fronthaul occupancy when the RIM-RS may be sent on a fronthaul interface from a radio unit to a distributed unit. When the processing of the RIM-RS is performed in the distributed unit, the distributed unit may need to trade off RIM-RS detection performance against an in-phase and quadrature (I-Q) sub-sampling. For example, the distributed unit may sample fewer antennas.

Moreover, if the RIM-RS processing is performed in the distributed unit, the radio unit may need to be provisioned with large sampling buffers to ensure that the RIM-RS of any delay is captured. Since the RIM-RS may span multiple slots and a physical resource block (PRB) range (e.g., an entire PRB range) for a given carrier, the radio unit may have a high buffering capacity. Furthermore, the RIM-RS processing at the radio unit (e.g., with associated fronthaul and distributed unit buffering and processing delays) may prevent the radio unit from entering a network energy saving state (e.g., a sleep state) quickly after a RIM-RS reception, resulting in high power consumption.

Aspects described herein may overcome the aforementioned technical problems and/or challenges, for example, by handling the RIM-RS processing at the radio unit. For example, a RIM-RS detection may occur at the radio unit, based on a RIM-RS configuration (e.g., including periodicity) sent to the radio unit. In certain aspects, the radio unit may generate and send, to the distributed unit, (e.g., only) relevant information, in a report, regarding identifying and reporting metrics for a detected RIM-RS. Such metrics may include, for example, derived metrics such as signal-to-interference plus noise ratio (SINR), reference signal received power (RSRP), beam direction, weights, etc.). The metrics may also capture post-radio unit beamforming I-Q samples related to the RIM-RS detection. Moreover, the radio unit may further be configured to enter or resume the network energy saving state (e.g., at the scope of the radio unit, carrier, chain, or antenna) subsequent to the detection of the RIM-RS.

Certain techniques for handling the RIM-RS processing at the radio unit described herein may provide various beneficial technical effects and/or advantages. The techniques for handling the RIM-RS processing at the radio unit described herein may enable improved wireless communications performance, such as reduced fronthaul occupancy and reduced network energy consumption. For example, the distributed unit may be able to operate within certain limits of fronthaul bandwidth (e.g., freeing up some of the fronthaul bandwidth that would otherwise be utilized for the RIM-RS processing). This reduction in fronthaul occupancy may be attributable to mitigating the need to send data regarding RIM-RS per each antenna to the distributed unit. Moreover, in the time domain, RIM-RSs may be transmitted periodically with a periodicity of a specific RIM-RS being in the order of seconds (or minutes). Thus, a radio unit receiver may be turned off for certain slots or symbols, and then may wake up to monitor the RIM-RS (e.g., only) at designated time. Furthermore, instead of accumulating samples spanning an entire RIM-RS configuration, the radio unit may potentially be turned off early if the radio unit identifies the RIM-RS in certain (e.g., early) slots (e.g., rather than staying on for the entirety of the length of time specified for the RIM-RS configuration). When the radio unit is turned off early, this may potentially result in reduced energy consumption. Further, a radio unit implementation with sufficient memory may delay or pipeline RIM-RS processing and resume on a best-effort basis at a subsequent wake-up time, thus allowing the reduced energy consumption.

In certain aspects, a distributed unit may sub-sample in-phase and quadrature (I-Q) samples for RIM-RS detection in the frequency, time, or space dimension in order to fit the RIM-RS within buffering limitations (per radio unit, endpoint, or group of endpoints, etc.). This behavior may be different than, for example, a behavior related to sounding reference signal (SRS), where the SRS behavior may be less demanding than the above behavior related to the RIM-RS. For example, an SRS may be configured in a few symbols in a slot (and multiple slots apart). This means that SRS raw antenna samples buffering requirements at the radio unit may be lower than that for RIM-RS, where relevant I-Q samples may span multiple slots. Furthermore, non-delay managed endpoints may be subject to capacity sharing, where this feature may be used more with RIM-RS than otherwise (e.g., without RIM-RS). This feature may enable sub-sampling of RIM-RS in space domain, where fewer endpoints than antennas may be used, to ensure that that the radio unit buffers are not overrun, which may be useful for cases with large antenna arrays. In some cases, semi-static RIM-RS configuration at the radio unit (e.g., via radio resource control (RRC) signaling) may enable the radio unit to collect I-Q samples for RIM-RS reception, covering RIM-RS specific parameters. For example, RIM-RS may cover multiple slots, and such configuration may be performed regardless of whether the RIM-RS detection occurs at the radio unit or whether the radio unit may be configured to enter the network energy saving state subsequent to the RIM-RS detection. In certain cases, a control, user, and synchronization (CUS) plane may specify how I-Q samples may be collected in a network energy saving state. The behaviors described above, for example, relating to the sub-sampling of I-Q samples and I-Q sample collection, together with the beneficial technical effects and/or advantages associated with the techniques for handling the RIM-RS processing at the radio unit, may further improve the load and energy savings.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz 71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182′′. UE 104 may also transmit a beamformed signal to the BS 180 in one or more transmit directions 182′′. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information. 5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

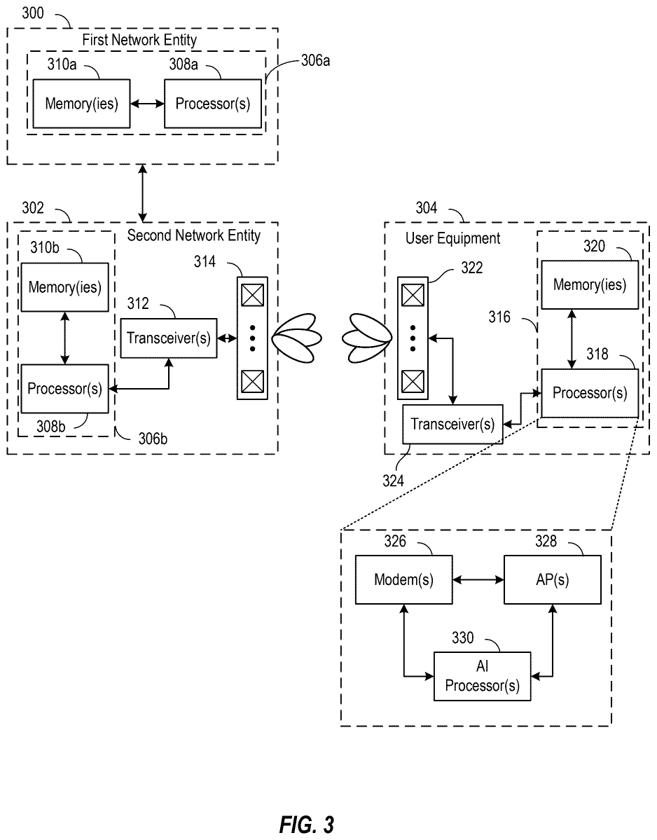

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

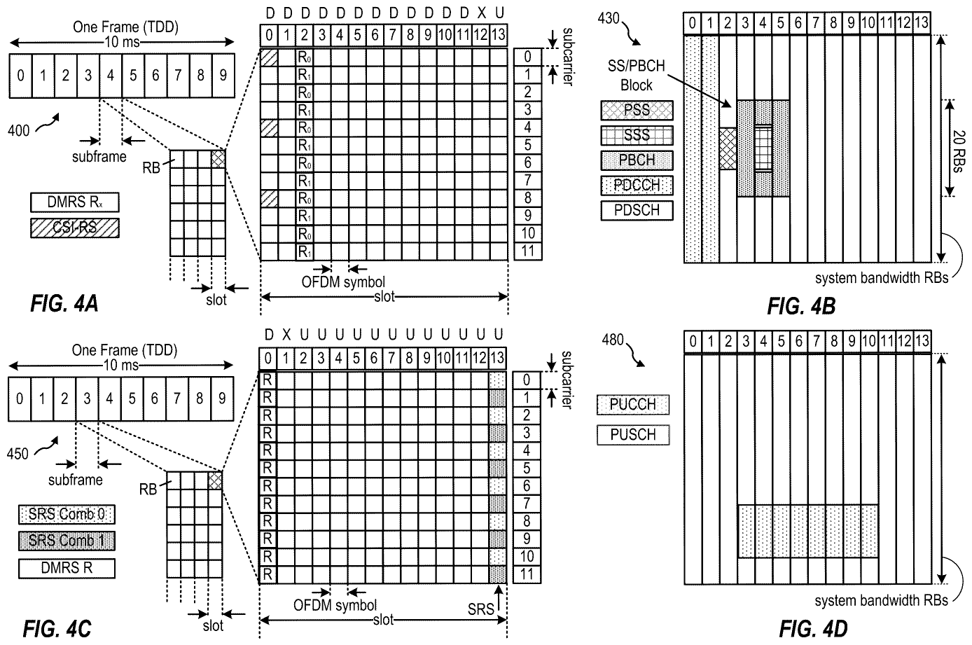

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology μ, there are 2^{μ}slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Remote Interference

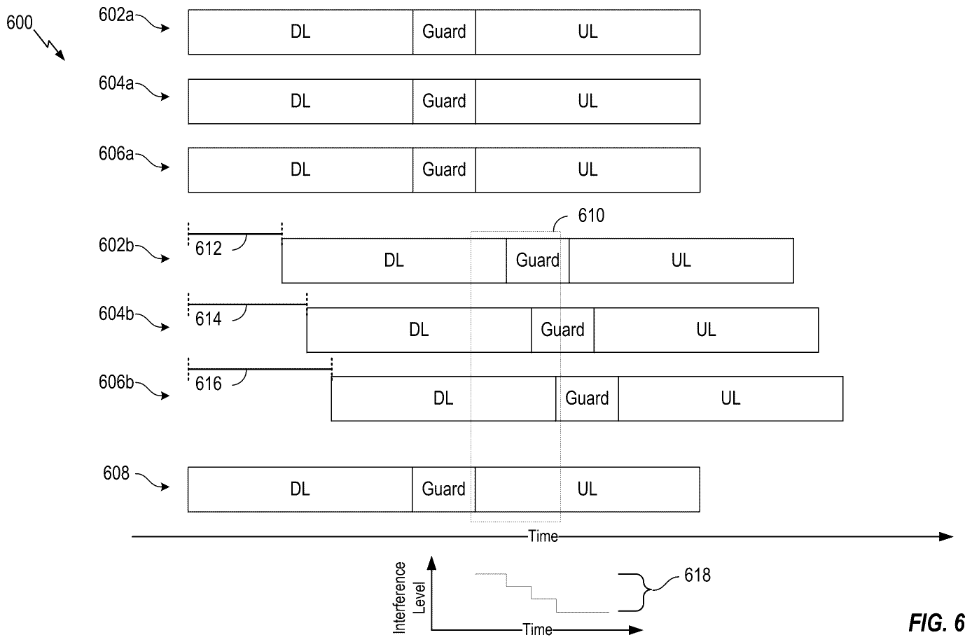

FIG. 5 depicts an illustration of an example 500 of a remote interference in a wireless communications network. The example 500 includes a first network entity (e.g., an aggressor network entity 502) and a second network entity (e.g., a victim network entity 504). In TDD-based wireless communications networks (e.g., TDD-based mobile networks), under certain atmospheric ducting conditions, an uplink reception at the victim network entity 504 may be interfered by downlink transmissions of the aggressor network entity 502 (e.g., remote gNBs) located hundreds of kilometers away. This interference is the remote interference. To mitigate the remote interference, an RIM-RS, described above, may be used to detect interference, for example, from multiple aggressor network entities. In TDD, guard periods are used between uplink reception and downlink transition which may be dimensioned according to the worst-case scenario propagation delay (e.g., a few OFDM symbols, accounting for neighboring network entities). While a first arrow 506 represents a typical range of transmission at a network entity (e.g., the aggressor network entity 502), the atmospheric ducting conditions may create an atmospheric duct (also referred to as a tropospheric duct) through which the transmission from the aggressor network entity 502 may travel a much greater distance (e.g., 150-400 km), such as greater than a radius of a coverage area of the aggressor network entity 502, to interfere with the uplink reception at the victim network entity 504. The transmission that travels the much greater distance due to the atmospheric ducting conditions is indicated by a second arrow 508 in FIG. 5. Additional details regarding the remote interference are described with reference to FIG. 6.

FIG. 6 depicts an example 600 of a remote interference in a wireless communications network. In the example 600, a first set of resources 602 a, a second set of resources 604a, and a third set of resources 606a correspond to three aggressor network entities. As depicted, each set of resources includes a period of time for downlink transmission, a guard period, and a period of time for uplink reception. These sets of resources may shift in time when they interfere with a victim network entity. For example, a fourth set of resources 608 corresponds to the victim network entity. A first shifted set of resources 602b, a second shifted set of resources 604b, and a third shifted set of resources 606b may be shifted sets of resources of, respectively, the first set of resources 602a, the second set of resources 604, and the third set of resources 606. For example, each of the shifted set of resources may be shifted by a propagation delay (e.g., a first propagation delay 612 for the first set of resources 602a, a second propagation delay 614 for the second set of resources 604a, and a third propagation delay 616 for the third set of resources 606a) that may be incurred when, for example, the downlink transmission from each of the three aggressor network entities has traveled a distance to interfere with the uplink reception at the victim network entity. For example, the third aggressor network entity (e.g., corresponding to the third set of resources 606a) may be the farthest away from the victim network entity, then the second aggressor network entity (e.g., corresponding to the second set of resources 604a), and then the first aggressor network entity (e.g., corresponding to the first set of resources 602a), based on the depicted propagation delays. As depicted in FIG. 6, there is an overlap 610 between (1) a portion of a first downlink transmission period of the first shifted set of resources 602b, a portion of a second downlink transmission period of the second shifted set of resources 604b, and a portion of a third downlink transmission period of the third shifted set of resources 606b, and (2) the uplink reception period of the fourth set of resources 608. A portion of the overlap 610 is affected by all three aggressor network entities, another portion of the overlap 610 is affected by two of the three aggressor network entities, and yet another portion of the overlap 610 is affected by one of the three aggressor network entities. As depicted in 618, the level of interference is at the highest when all three aggressor network entities are interfering with the victim network entity (e.g., at a first uplink symbol), then when two aggressor network entities are interfering with the victim network entity, and the level interference is at the lowest when just one of the aggressor network entities is interfering with the victim network entity.

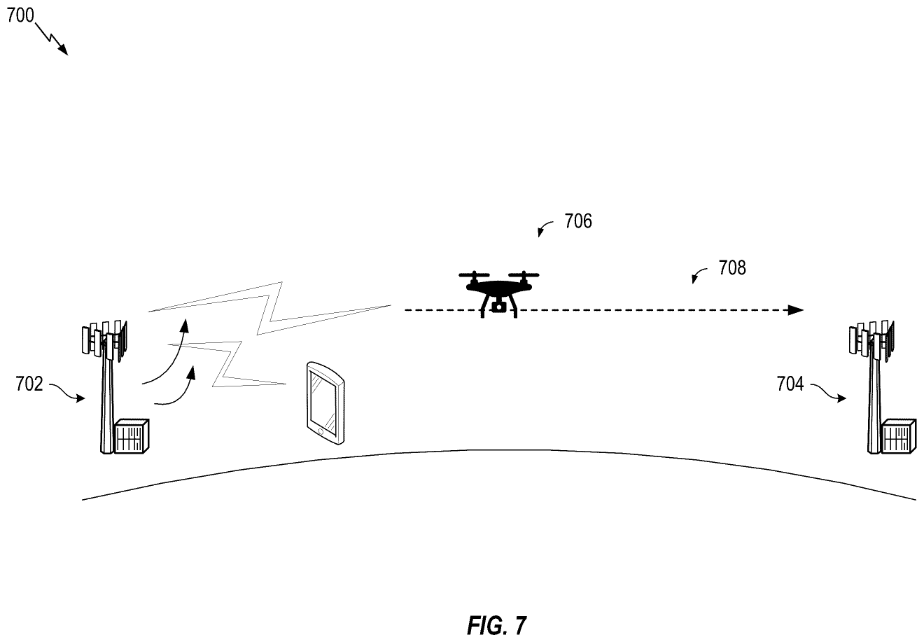

FIG. 7 depicts an illustration of another example 700 of a remote interference in a wireless communications network. The example 700 includes a first network entity (e.g., an aggressor network entity 702) and a second network entity (e.g., a victim network entity 704). As depicted, there may be a similar remote interference 708 in an unmanned aerial vehicle (UAV) (e.g., drone) use case (e.g., even in the absence of atmospheric or tropospheric tunnelling conditions), such as in the presence of a UAV 706. The RIM-RS described herein may allow a formation of a semi-static interference map, such as to identify atmospheric (e.g., tropospheric) interference. Down-tilt may be a tool to limit inter-cell interference, but the UAV use cases may require increasing elevation, at least at beam level. Unlike the traditional atmospheric or tropospheric interference case, the UAV use case may also apply to deployment with large antenna panels. The RIM-RS may address interference introduced by this additional UAV use case. The beamforming gain may result in interference beyond immediate neighbor cells, or narrow down interference in specific beam directions. This may allow network entities (e.g., base stations) to take or coordinate interference avoidance techniques (e.g., for UAV use cases).

### Example Signaling of Handling Remote Interference Management Reference Signal-Related Processing in a Radio Unit

Certain aspects of the present disclosure may enable a radio unit to advertise its support for RIM-RS measurement (e.g., RIM-RS measurement objects), be configured with a RIM-RS measurement configuration (and a RIM-RS measurement report configuration), receive and process a RIM-RS, and send a RIM-RS measurement report based on the RIM-RS processing.

In certain aspects, a radio unit may transmit (e.g., advertise), to a distributed unit, an indication of a capability to support a RIM-RS measurement. The radio unit may obtain, from the distributed unit, a first configuration related to the RIM-RS measurement and a second configuration related to an RIM-RS measurement report. The radio unit may perform the RIM-RS measurement in accordance with the first configuration. The radio unit may transmit, to the distributed unit, the RIM-RS measurement report in accordance with the second configuration. The first configuration may, for example, include a distributed unit-specific RIM-RS configuration including one or more of: a RIM-RS monitoring start time, a RIM-RS monitoring stop time, a RIM-RS monitoring window length, a RIM-RS monitoring window starting offset, a RIM-RS monitoring window periodicity, a RIM-RS monitoring occasion interval, or a RIM-RS monitoring occasion starting offset.

In some cases, the first configuration and the second configuration may be obtained using a control plane interface or a management plane interface. Then, the RIM-RS measurement report may be transmitted using the control plane interface or a user plane interface. In certain cases, the radio unit may also obtain (e.g., for advanced sleep mode (ASM)) a third configuration including an indication to resume or enter a network energy saving state (e.g., a sleep state), such as after detecting the RIM-RS for the RIM-RS measurement. As described herein, the radio unit may not need to monitor the entirety of a length of time configured for the RIM-RS detection. Such configuration to resume or enter the network energy saving state may be obtained using a control plane interface or a management plane interface. Moreover, transmitting the RIM-RS measurement report may include transmitting the RIM-RS measurement report by using a control plane interface or a user plane interface.

In certain cases, the radio unit may obtain another configuration related to a sub-sampling related to an RIM-RS for the RIM-RS measurement. The sub-sampling may be in at least one of a frequency dimension, a time dimension, or a space dimension, where the RIM-RS measurement report may be based on the sub-sampling in accordance with this configuration, and the sub-sampling may be related to one or more RIM-RS specific parameters.

In some cases, the radio unit may obtain yet another configuration related to an I-Q sample collection for an RIM-RS for the RIM-RS measurement, where performing the RIM-RS measurement may include performing the RIM-RS measurement in accordance with this configuration by using one or more receive endpoints and/or one or more carrier signals.

In certain cases, the advertised capability may include a capability, related to one or more receive endpoints, for processing one or more RIM-RSs via the one or more receive endpoints. For example, such capability may indicate a maximum number of RIM-RS time or frequency resources for processing.

In some cases, transmitting the indication, obtaining the first configuration and the second configuration, and transmitting the RIM-RS measurement report may be performed using a management plane interface. Here, the advertised capability may indicate a measurement object type related to the RIM-RS measurement report, as well as a plurality of instances of a measurement object type related to the RIM-RS measurement report, where a number of the plurality of instances of the measurement object type may be based on a number of configurations related to the RIM-RS measurement that the radio unit supports.

In certain cases, the radio unit may obtain, from the distributed unit, an indication to start or stop receiving an RIM-RS. The radio unit may transmit, to the distributed unit, a confirmation of obtaining this indication, and start or stop receiving the RIM-RS in accordance with the indication.

In some cases, the advertised capability may indicate an endpoint support for: a Section Type 11 (ST-11) messaging type, and a total RIM-RS buffering capability. Furthermore, the radio unit may obtain, from the distributed unit and using a control user synchronization plane interface, an ST-11 message including a request to transmit the RIM-RS measurement report. The radio unit may transmit, to the distributed unit, a Section Type 10 (ST-10) message including the RIM-RS measurement report. ST-11 is a section type which is used by a distributed unit for requesting a radio unit to send a specific measurement report. An ST-11 message may request a specific measurement command from the radio unit. For RIM-RS, a measurement command may be used, where the measurement command may trigger the radio unit to send the RIM-RS measurement report. ST-10 is a section type which is used by a radio unit for sending measurement reports to a distributed unit. Multiple measurement reports may be sent using a ST-10 message. For sending a RIM-RS measurement report, a measurement type may be used for the ST-10 message.

In certain cases, the radio unit may also obtain an RIM-RS from a network entity (e.g., an aggressor network entity), wherein the RIM-RS measurement report would be related to this network entity. The radio unit may initiating an RIM procedure related to this network entity based on the RIM-RS measurement report.

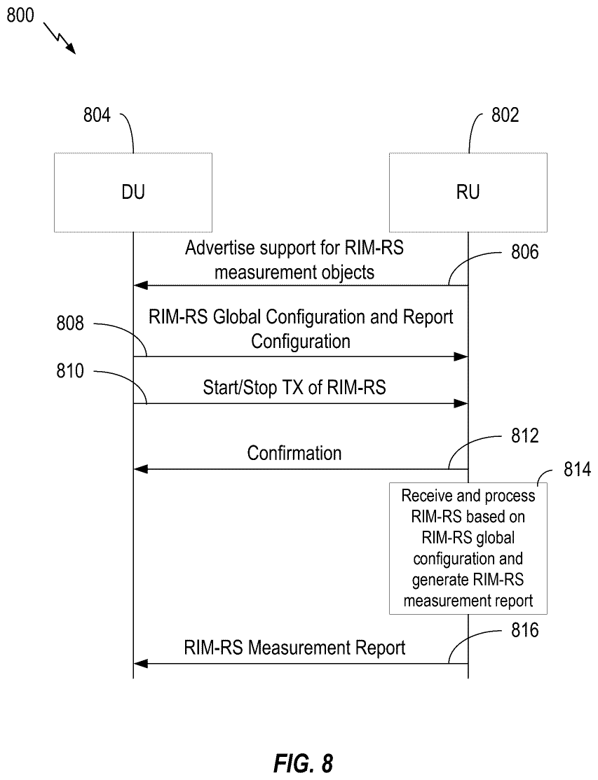

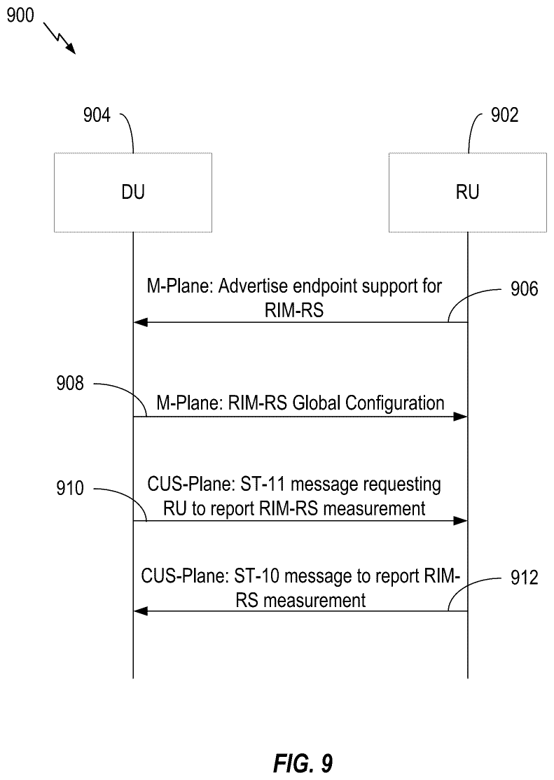

Additional details regarding the handling of the RIM-RS-related processing in the radio unit, described above, are described further, below, with reference to process flows depicted in FIGS. 8 and 9.

In certain aspects, a RIM-RS measurement configuration (e.g., a RIM-RS global configuration) may be made available to a radio unit over a management plane interface. The RIM-RS global configuration may be used to represent global or common RIM-RS resource allocated for the whole network. Resource for RIM-RS transmission may be defined by (1) sequence domain resource, (2) time domain resource, and (3) frequency domain resource. The configured parameters of the RIM RS resource may be applied to all sets of RIM RS resource across multiple (e.g., all) base stations (e.g., gNBs)/cells in the network.

In some aspects, the radio unit may receive a RIM-RS reporting configuration, which may include, for example: a report indicator, a report interval, a number of RIM-RS reports (such as a maximum length of RIM-RS report information list), a maximum propagation delay (e.g., indicating that the maximum propagation delay to be reported will be in the range of [0, 1, . . . , (maximum propagation delay value or indicator)], and a RIM-RS report information list. In certain cases, a report indicator may be used to enable or disable a RIM-RS report at the radio unit. If the indication corresponds to the report being enabled, the radio unit may start to periodically report necessary information derived from the detected RIM-RS to the distributed unit. If the indication corresponds to the report being disabled, the radio unit may stop such reporting. In some cases, the RIM-RS report information list may include a list of elements, such as: a RIM-RS information (which may be defined as a tuple, such as (detected set identifier, propagation delay, functionality of RIM-RS (e.g. RS1/RS2/RS1 with enough mitigation or RS2 with enough mitigation))).

In certain aspects, the radio unit may obtain a RIM-RS configuration that is distributed unit-specific, such as a monitoring window configuration including one or more of: a RIM-RS monitoring start time, a RIM-RS monitoring stop time, a RIM-RS monitoring window length, a RIM-RS monitoring window starting offset, a RIM-RS monitoring window periodicity, a RIM-RS monitoring occasion interval, or a RIM-RS monitoring occasion starting offset. This configuration may be applicable even when the RIM-RS is detected in the distributed unit (as well as when the RIM-RS is detected in the radio unit, as described herein).

Referring now to FIG. 8, FIG. 8 depicts a process flow 800 for communications in a network between a radio unit 802 and a distributed unit 804. In some aspects, the radio unit 802 and the distributed unit 804 may be, respectively, examples of (e.g., functional components of) the BS 102 depicted and described with respect to FIG. 1, the first network entity 300 or the second network entity 302 depicted and described with respect to FIG. 3, or a disaggregated base station depicted and described with respect to FIG. 2. For example, the radio unit 802 may be an example of the second network entity 302 of FIG. 3, and the distributed unit 804 may be an example of the first network entity 300 of FIG. 3. Note that any operations or signaling illustrated with dashed lines may indicate that that operation or signaling is an optional or alternative example.

The process flow 800 is an example of process flow for using a fronthaul management plane interface. Since a RIM-RS measurement configuration (e.g., RIM-RS global configuration) and a RIM-RS measurement report configuration may not change dynamically over a short time frame, it may be possible to use the fronthaul management plane interface for communicating the RIM-RS measurement configuration and the RIM-RS measurement report, including configuring the RIM-RS measurement configuration and the RIM-RS measurement report configuration at the radio unit. Support for the RIM-RS measurement configuration at the radio unit, performing the RIM-RS measurement at the radio unit, and reporting of the RIM-RS measurement by the radio unit may be realized using a measurement framework in the fronthaul interface.

At 806, the radio unit 802 advertises, to the distributed unit 804, support for RIM-RS measurement objects. The advertised support for RIM-RS measurement objects may correspond to the indication of capability to support the RIM-RS measurement described above. In certain cases, the advertised support may be to process RIM-RS in the radio unit 802 by specific receive endpoints. In some cases, the advertised support may include a list of supported capabilities for RIM-RS, including a maximum number of RIM-RS resources that the radio unit 802 can process in total and in time and frequency resources. In certain cases, the advertised support may include a support or a measurement object type to be used for reporting RIM-RS from the radio unit 802 to the distributed unit 804. Multiple instances of this object may be advertised by the radio unit 802, depending on how many RIM-RS global sets the radio unit 802 can support. For example, each RIM-RS measurement object may be associated with a measurement interval (e.g., defined in terms of seconds) to perform measurements periodically. Start-time and end-time for each measurement internal for each RIM-RS measurement object may be indicated using these parameters. Additionally, a notification interval for each RIM-RS measurement object may be configured for measurement reporting.

At 808, the radio unit 802 obtains, from the distributed unit 804, a RIM-RS global configuration (e.g., a RIM-RS measurement configuration) and a report configuration (e.g., a RIM-RS measurement report configuration). The RIM-RS global configuration and the report configuration correspond to the first configuration (e.g., the RIM-RS measurement configuration) and the second configuration (e.g., the RIM-RS measurement configuration) described above.

At 810, the radio unit 802 obtains, from the distributed unit 804, a request to start or stop transmission of RIM-RS. The request to start or stop transmission of RIM-RS may correspond to the indication to start or stop receiving an RIM-RS described above.

At 812, the radio unit 802 transmits, to the distributed unit 804, a confirmation of the request obtained at 810.

At 814, the radio unit 802 receives and processes a RIM-RS based on the RIM-RS global configuration, and generates a RIM-RS measurement report.

At 816, the radio unit 802 transmits, to the distributed unit 804, the RIM-RS measurement report.

As the process flow 800 enables the radio unit 802 to handle the RIM-RS processing (e.g., the RIM-RS measurement), the process flow 800 may provide the technical benefit of enabling reduction in network load (e.g., in the fronthaul bandwidth usage) and network energy consumption (e.g., allowing the radio unit to enter a network energy saving state without having to monitor all of the length of time configured for RIM-RS).

Note that the process flow illustrated in FIG. 8 is an example of handling RIM-RS-related processing in a radio unit, and aspects of the present disclosure may be applied to handling RIM-RS-related processing in a radio unit. Note that the process flow illustrated in FIG. 8 is described herein to facilitate an understanding of handling RIM-RS-related processing in a radio unit, and aspects of the present disclosure may be performed in various manners via alternative or additional signaling and/or operations. In certain aspects, the operations and/or signaling of FIG. 8 may occur in an order different from that described or depicted, and various actions, operations, and/or signaling may be added, omitted, or combined.

FIG. 9 depicts a process flow 900 for communications in a network between a radio unit 902 and a distributed unit 904. In some aspects, the radio unit 902 and the distributed unit 904 may be, respectively, examples of (e.g., functional components of) the BS 102 depicted and described with respect to FIG. 1, the first network entity 300 or the second network entity 302 depicted and described with respect to FIG. 3, or a disaggregated base station depicted and described with respect to FIG. 2. For example, the radio unit 902 may be an example of the second network entity 302 of FIG. 3, and the distributed unit 904 may be an example of the first network entity 300 of FIG. 3. Note that any operations or signaling illustrated with dashed lines may indicate that that operation or signaling is an optional or alternative example.

The process flow 900 is an example of process flow for using, at least in part, a fronthaul control, user, and synchronization plane interface. The fronthaul control, user, and synchronization plane may be used for any measurement in the radio unit 902 which is on received I-Q samples, for example, even when the measurement and reporting may not have real-time requirement. Thus, RIM-RS per antenna reception and processing in the radio unit 902 may be based on the control, user, and synchronization plane. A management plane interface may be used for advertising endpoint support for RIM-RS and for obtaining a RIM-RS measurement configuration, and a control, user, and synchronization plane interface may be used for the ST-11 message described below.

At 906, the radio unit 902 advertises, to the distributed unit 904 (and over a management plane (sometimes referred to as “M-Plane”), endpoint support for RIM-RS. For example, the advertised support information may be to process RIM-RS by specific receive endpoints. The advertised support information may also include a list of capabilities supported for RIM-RS, including a maximum number of RIM-RS resources that the radio unit 902 can process in total and in time and frequency resources. Furthermore, the advertised support information may include a support for ST-11 message for specific receive endpoints which may support processing of RIM-RS in the radio unit 902. In certain cases, individual non-delay managed endpoints per antenna port for RIM-RS reception may not be defined.

At 908, the radio unit 902 obtains, from the distributed unit 904 (and over the management plane), a RIM-RS global configuration (e.g., a RIM-RS measurement configuration). The configuration may be for RIM-RS supported endpoints.

At 910, the radio unit 902 obtains, from the distributed unit 904 (and over a control, user, and synchronization plane (CUS-Plane)), an ST-11 message requesting the radio unit 902 to report a RIM-RS measurement. The ST-11 message may be accompanied by an indication of a requirement to add a new measurement type (e.g., including a measurement type identifier). Since the ST-11 message may be per slot, the new measurement type for RIM-RS may include parameters that apply to multiple slots.

At 912, the radio unit 902 transmits, to the distributed unit 904 (and over the control, user, and synchronization plane), an ST-10 message to report the RIM-RS measurement.

For the radio unit 902 to perform RIM-RS measurements, the radio unit 902 may use a RIM-RS measurement configuration (e.g. the RIM-RS global configuration), a RIM-RS measurement report configuration, and a RIM-RS reporting information, which may be exchanged over the management plane. The ST-11 message may serve as a trigger for the radio unit 902 to send the RIM-RS measurement report based on the RIM-RS measurement report configuration and the RIM-RS reporting information. In some cases, the RIM-RS measurement report configuration may specify the time resource(s), frequency resource(s), and/or antenna port(s) for receiving the RIM-RS. The RIM-RS reporting information may specify how often a RIM-RS measurement may be reported from the radio unit 902 to the distributed unit 904 (e.g., once the RIM-RS measurements have been performed).

A new measurement type for RIM-RS structured according to the RIM-RS reporting information (e.g., including the actual measurement report) may be supported for the ST-10 message.

Similar to the process flow 800 described above, the process flow 900 enables the radio unit 902 to handle the RIM-RS processing (e.g., the RIM-RS measurement), and the process flow 900 may provide the technical benefit of enabling reduction in network load (e.g., in the fronthaul bandwidth usage) and network energy consumption (e.g., allowing the radio unit to enter a network energy saving state without having to monitor all of the length of time configured for RIM-RS).

Note that the process flow illustrated in FIG. 9 is an example of handling RIM-RS-related processing in a radio unit, and aspects of the present disclosure may be applied to handling RIM-RS-related processing in a radio unit. Note that the process flow illustrated in FIG. 9 is described herein to facilitate an understanding of handling RIM-RS-related processing in a radio unit, and aspects of the present disclosure may be performed in various manners via alternative or additional signaling and/or operations. In certain aspects, the operations and/or signaling of FIG. 9 may occur in an order different from that described or depicted, and various actions, operations, and/or signaling may be added, omitted, or combined.

### Example Operations of a Radio Unit

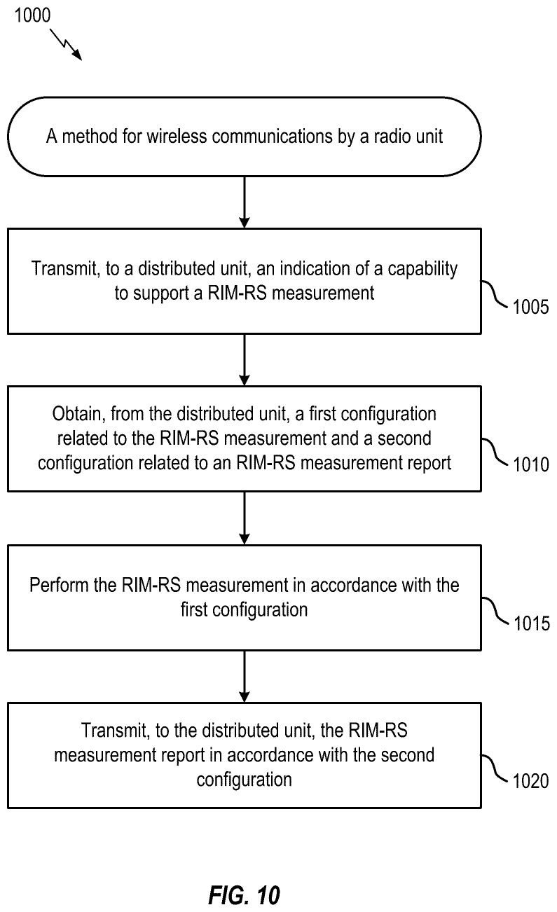

FIG. 10 shows a method 1000 for wireless communications by a radio unit, which may be an example of (e.g., a functional component of) BS 102 of FIG. 1, a first network entity 300 or second network entity 302 of FIG. 3, or a disaggregated base station as discussed with respect to FIG. 2.

Method 1000 begins at block 1005 with transmitting, to a distributed unit, an indication of a capability to support a RIM-RS measurement. For example, the indication of the capability may correspond to the advertised support described herein with reference to step 806 of FIG. 8 or the advertised endpoint support described herein with reference to step 906 of FIG. 9.

Method 1000 then proceeds to block 1010 with obtaining, from the distributed unit, a first configuration related to the RIM-RS measurement and a second configuration related to an RIM-RS measurement report. For example, the first configuration and the second configuration may correspond to, respectively, the RIM-RS global configuration and the report configuration described herein with reference to step 808 of FIG. 8 and the RIM-RS global configuration described herein with reference to step 908 of FIG. 9.

Method 1000 then proceeds to block 1015 with performing the RIM-RS measurement in accordance with the first configuration.

Method 1000 then proceeds to block 1020 with transmitting, to the distributed unit, the RIM-RS measurement report in accordance with the second configuration. For example, the RIM-RS measurement report may correspond to the RIM-RS measurement report described herein with reference to step 816 of FIG. 8 or the ST-10 message reporting the RIM-RS measurement described herein with reference to step 912 of FIG. 9.

In some aspects, block 1010 includes obtaining, using a control plane interface or a management plane interface, the first configuration and the second configuration.

In some aspects, block 1020 includes transmitting, using a control plane interface or a user plane interface, the RIM-RS measurement report.

In some aspects, method 1000 further includes obtaining a third configuration comprising an indication to resume or enter a network energy saving state after detecting an RIM-RS for the RIM-RS measurement.

In some aspects, obtaining the third configuration comprises obtaining, using a control plane interface or a management plane interface, the third configuration.

In some aspects, block 1020 includes transmitting, using a control plane interface or a user plane interface, the RIM-RS measurement report.

In some aspects, method 1000 further includes obtaining a third configuration related to a sub-sampling related to an RIM-RS for the RIM-RS measurement, the sub-sampling in at least one of a frequency dimension, a time dimension, or a space dimension, wherein the RIM-RS measurement report is based on the sub-sampling in accordance with the third configuration, the RIM-RS measurement report being based on the sub-sampling related to one or more RIM-RS specific parameters.

In some aspects, method 1000 further includes obtaining a third configuration related to an I-Q sample collection for an RIM-RS for the RIM-RS measurement, wherein block 1015 includes performing the RIM-RS measurement, in accordance with the third configuration, using at least one of one or more receive endpoints or one or more carrier signals.

In some aspects, the capability comprises a capability, related to one or more receive endpoints, for processing one or more RIM-RSs via the one or more receive endpoints.

In some aspects, the capability comprises a capability, related to one or more receive endpoints, indicating a maximum number of RIM-RS time or frequency resources for processing.

In some aspects, transmitting the indication, obtaining the first configuration and the second configuration, and block 1020 includes: transmitting the indication using a management plane interface; obtaining the first configuration and the second configuration using the management plane interface; and transmitting the RIM-RS measurement report using the management plane interface.

In some aspects, the capability indicates a measurement object type related to the RIM-RS measurement report.

In some aspects, the capability indicates a plurality of instances of a measurement object type related to the RIM-RS measurement report, wherein a number of the plurality of instances of the measurement object type is based on a number of configurations related to the RIM-RS measurement that the radio unit supports.

In some aspects, method 1000 further includes obtaining, from the distributed unit, another indication to start or stop receiving an RIM-RS.

In some aspects, method 1000 further includes transmitting, to the distributed unit, a confirmation of obtaining the other indication.

In some aspects, method 1000 further includes starting or stopping receiving the RIM-RS in accordance with the other indication.

In some aspects, the capability indicates an endpoint support for: an ST-11 messaging type, and a total RIM-RS buffering capability.

In some aspects, method 1000 further includes, using a control user synchronization plane interface: obtaining, from the distributed unit, an ST-11 message comprising a request to transmit the RIM-RS measurement report using a control user synchronization plane interface; and transmitting, to the distributed unit, an ST-10 message comprising the RIM-RS measurement report using a control user synchronization plane interface.

In some aspects, method 1000 further includes obtaining an RIM-RS from a network entity, wherein the RIM-RS measurement report is related to the network entity.

In some aspects, method 1000 further includes initiating an RIM procedure related to the network entity based on the RIM-RS measurement report.

In some aspects, the first configuration comprises a distributed unit-specific RIM-RS configuration comprising one or more of: a RIM-RS monitoring start time, a RIM-RS monitoring stop time, a RIM-RS monitoring window length, a RIM-RS monitoring window starting offset, a RIM-RS monitoring window periodicity, a RIM-RS monitoring occasion interval, or a RIM-RS monitoring occasion starting offset.

As the method 1000 enables a radio unit to handle the RIM-RS processing (e.g., the RIM-RS measurement), the method 1000 may provide the technical benefit of enabling reduction in network load (e.g., in the fronthaul bandwidth usage) and network energy consumption (e.g., allowing the radio unit to enter a network energy saving state without having to monitor all of the length of time configured for RIM-RS).

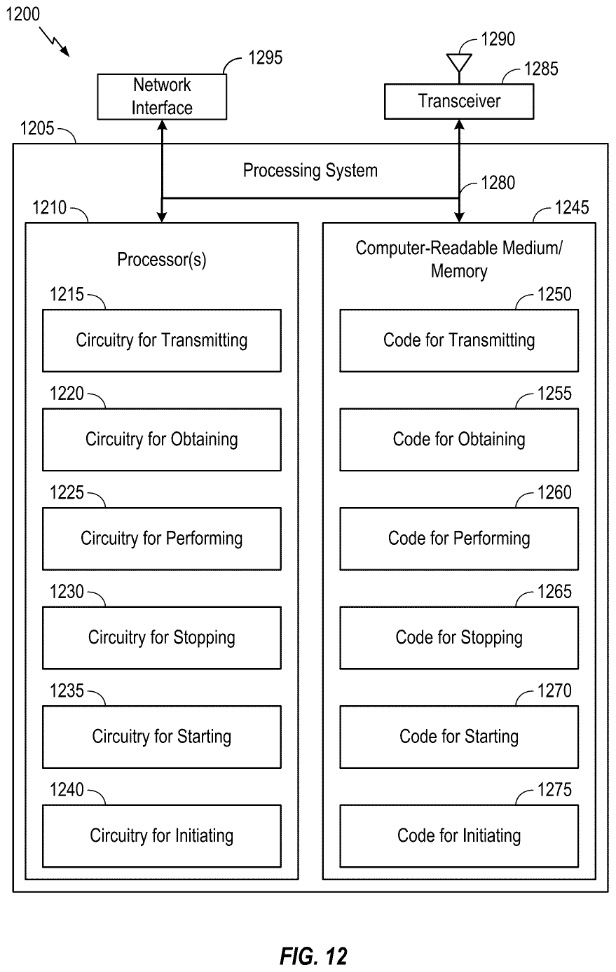

In some aspects, method 1000, or any aspect related to it, may be performed by an apparatus, such as communications device 1200 of FIG. 12, which includes various components operable, configured, or adapted to perform the method 1000. Communications device 1200 is described below in further detail.

Note that FIG. 10 is just one example of a method, and other methods including fewer, additional, or alternative operations are possible consistent with this disclosure.

### Example Operations of a Distributed Unit

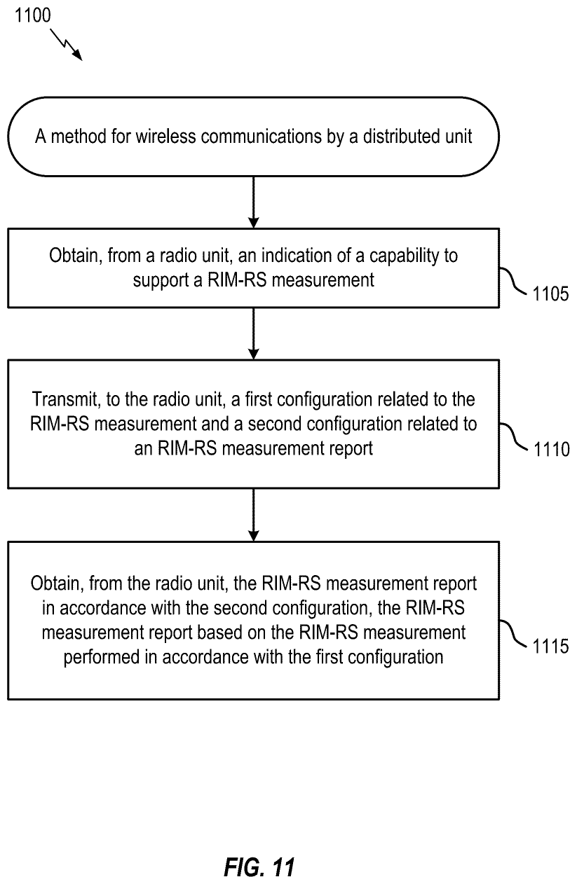

FIG. 11 shows a method 1100 for wireless communications by a distributed unit, which may be an example of (e.g., a functional component of) BS 102 of FIG. 1, a first network entity 300 or second network entity 302 of FIG. 3, or a disaggregated base station as discussed with respect to FIG. 2.

Method 1100 begins at block 1105 with obtaining, from a radio unit, an indication of a capability to support a RIM-RS measurement. For example, the indication of the capability may correspond to the advertised support described herein with reference to step 806 of FIG. 8 or the advertised endpoint support described herein with reference to step 906 of FIG. 9.

Method 1100 then proceeds to block 1110 with transmitting, to the radio unit, a first configuration related to the RIM-RS measurement and a second configuration related to an RIM-RS measurement report. For example, the first configuration and the second configuration may correspond to, respectively, the RIM-RS global configuration and the report configuration described herein with reference to step 808 of FIG. 8 and the RIM-RS global configuration described herein with reference to step 908 of FIG. 9.

Method 1100 then proceeds to block 1115 with obtaining, from the radio unit, the RIM-RS measurement report in accordance with the second configuration, the RIM-RS measurement report based on the RIM-RS measurement performed in accordance with the first configuration. For example, the RIM-RS measurement report may correspond to the RIM-RS measurement report described herein with reference to step 816 of FIG. 8 or the ST-10 message reporting the RIM-RS measurement described herein with reference to step 912 of FIG. 9.

In some aspects, block 1110 includes transmitting, using a control plane interface or a management plane interface, the first configuration and the second configuration.

In some aspects, block 1115 includes obtaining, using a control plane interface or a user plane interface, the RIM-RS measurement report.

In some aspects, method 1100 further includes transmitting a third configuration comprising an indication to resume or enter a network energy saving state after detecting an RIM-RS for the RIM-RS measurement.

In some aspects, transmitting the third configuration comprises transmitting, using a control plane interface or a management plane interface, the third configuration.

In some aspects, block 1115 includes obtaining, using a control plane interface or a user plane interface, the RIM-RS measurement report.

In some aspects, method 1100 further includes transmitting a third configuration related to a sub-sampling related to an RIM-RS for the RIM-RS measurement, the sub-sampling in at least one of a frequency dimension, a time dimension, or a space dimension, wherein the RIM-RS measurement report is based on the sub-sampling in accordance with the third configuration, the RIM-RS measurement report being based on the sub-sampling related to one or more RIM-RS specific parameters.

In some aspects, method 1100 further includes transmitting a third configuration related to an I-Q sample collection for an RIM-RS for the RIM-RS measurement, wherein the RIM-RS measurement is performed, in accordance with the third configuration, using at least one of one or more receive endpoints or one or more carrier signals.

In some aspects, the capability comprises a capability, related to one or more receive endpoints, for processing one or more RIM-RSs via the one or more receive endpoints.

In some aspects, the capability comprises a capability, related to one or more receive endpoints, indicating a maximum number of RIM-RS time or frequency resources for processing.

In some aspects, block 1105, block 1110, and block 1115 include: obtaining the indication using a management plane interface; transmitting the first configuration and the second configuration using the management plane interface; and obtaining the RIM-RS measurement report using the management plane interface.

In some aspects, the capability indicates a measurement object type related to the RIM-RS measurement report.

In some aspects, the capability indicates a plurality of instances of a measurement object type related to the RIM-RS measurement report, wherein a number of the plurality of instances of the measurement object type is based on a number of configurations related to the RIM-RS measurement that the radio unit supports.

In some aspects, method 1100 further includes transmitting, to the radio unit, another indication to start or stop receiving an RIM-RS.

In some aspects, method 1100 further includes obtaining, from the radio unit, a confirmation of obtaining the other indication.

In some aspects, the capability indicates an endpoint support for: an ST-11 messaging type, and a total RIM-RS buffering capability.

In some aspects, method 1100 further includes transmitting, to the radio unit, an ST-11 message comprising a request to transmit the RIM-RS measurement report using a control user synchronization plane interface.

In some aspects, method 1100 further includes obtaining, from the radio unit, an ST-10 message comprising the RIM-RS measurement report using a control user synchronization plane interface.

In some aspects, the first configuration comprises a distributed unit-specific RIM-RS configuration comprising one or more of: a RIM-RS monitoring start time, a RIM-RS monitoring stop time, a RIM-RS monitoring window length, a RIM-RS monitoring window starting offset, a RIM-RS monitoring window periodicity, a RIM-RS monitoring occasion interval, or a RIM-RS monitoring occasion starting offset.

Similar to the method 1000 described above, the method 1100 enables a radio unit to handle the RIM-RS processing (e.g., the RIM-RS measurement), and the method 1100 may provide the technical benefit of enabling reduction in network load (e.g., in the fronthaul bandwidth usage) and network energy consumption (e.g., allowing the radio unit to enter a network energy saving state without having to monitor all of the length of time configured for RIM-RS).

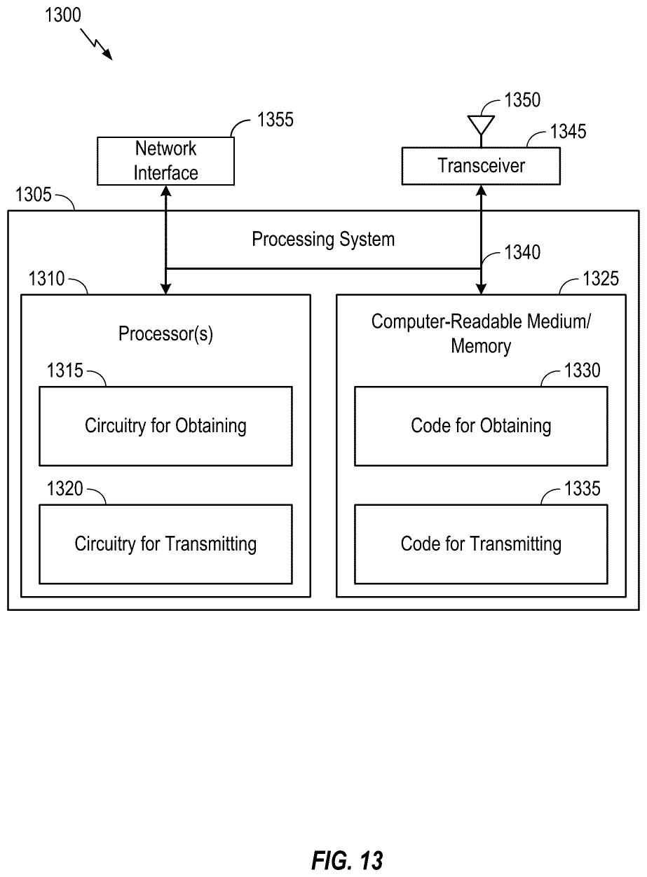

In some aspects, method 1100, or any aspect related to it, may be performed by an apparatus, such as communications device 1300 of FIG. 13, which includes various components operable, configured, or adapted to perform the method 1100. Communications device 1300 is described below in further detail.

Note that FIG. 11 is just one example of a method, and other methods including fewer, additional, or alternative operations are possible consistent with this disclosure.

### Example Communications Devices

FIG. 12 depicts aspects of an example communications device 1200 configured for wireless communications. In some aspects, communications device 1200 is a radio unit, which may be an example of (e.g., a functional component of) BS 102 of FIG. 1, a first network entity 300 or second network entity 302 of FIG. 3, or a disaggregated base station as discussed with respect to FIG. 2, as well as a radio unit 802 of FIG. 8 and a radio unit 902 of FIG. 9.

The communications device 1200 includes a processing system 1205 coupled to a transceiver 1285 (e.g., a transmitter and/or a receiver). The transceiver 1285 is configured to transmit and receive signals for the communications device 1200 via an antenna 1290, such as the various signals as described herein. The network interface 1295 is configured to obtain and send signals for the communications device 1200 via communications link(s), such as a fronthaul link as described herein, such as with respect to FIG. 2. The processing system 1205 may be configured to perform processing functions for the communications device 1200, including processing signals received and/or to be transmitted by the communications device 1200.

The processing system 1205 includes one or more processors 1210 and a computer-readable medium/memory 1245. In various aspects, the one or more processors 1210 may be representative of the one or more processors 318 described with respect to FIG. 3. The one or more processors 1210 are coupled to a computer-readable medium/memory 1245 via a bus 1280. In some aspects, the computer-readable medium/memory 1245 may be representative of the one or more memories 320 described with respect to FIG. 3. The computer-readable medium/memory 1245 is a non-transitory computer-readable medium/memory. In certain aspects, the computer-readable medium/memory 1245 is configured to store instructions (e.g., computer-executable code), that when executed by the one or more processors 1210, cause the one or more processors 1210 to perform the method 1000 described with respect to FIG. 10, or any aspect related to it, including any operations described in relation to FIG. 10. Note that reference to a processor performing a function of communications device 1200 may include one or more processors performing that function of communications device 1200, such as in a distributed fashion.

In the depicted example, computer-readable medium/memory 1245 stores code (e.g., executable instructions), including code for transmitting 1250, code for obtaining 1255, code for performing 1260, code for stopping 1265, code for starting 1270, and code for initiating 1275. Processing of the code 1250-1275 may enable and cause the communications device 1200 to perform the method 1000 described with respect to FIG. 10, or any aspect related to it. For instance, in some aspects, code for transmitting 1250 includes code for transmitting, to a distributed unit, an indication of a capability to support a RIM-RS measurement. In some aspects, code for obtaining 1255 includes code for obtaining, from the distributed unit, a first configuration related to the RIM-RS measurement and a second configuration related to an RIM-RS measurement report. In some aspects, code for performing 1260 includes code for performing the RIM-RS measurement in accordance with the first configuration. In some aspects, code for transmitting 1250 includes code for transmitting, to the distributed unit, the RIM-RS measurement report in accordance with the second configuration.

The one or more processors 1210 include circuitry configured to implement (e.g., execute) the code stored in the computer-readable medium/memory 1245, including circuitry for transmitting 1215, circuitry for obtaining 1220, circuitry for performing 1225, circuitry for stopping 1230, circuitry for starting 1235, and circuitry for initiating 1240. Processing with circuitry 1215-1240 may enable and cause the communications device 1200 to perform the method 1000 described with respect to FIG. 10, or any aspect related to it. For instance, in some aspects, circuitry for transmitting 1215 includes circuitry for transmitting, to a distributed unit, an indication of a capability to support a RIM-RS measurement. In some aspects, circuitry for obtaining 1220 includes circuitry for obtaining, from the distributed unit, a first configuration related to the RIM-RS measurement and a second configuration related to an RIM-RS measurement report. In some aspects, circuitry for performing 1225 includes circuitry for performing the RIM-RS measurement in accordance with the first configuration. In some aspects, circuitry for transmitting 1215 includes circuitry for transmitting, to the distributed unit, the RIM-RS measurement report in accordance with the second configuration.

Various components of the communications device 1200 may provide means for performing the method 1000 described with respect to FIG. 10, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1285, antenna 1290, and/or network interface 1295 of the communications device 1200 in FIG. 12, and/or one or more processors 1210 of the communications device 1200 in FIG. 12. Means for communicating, receiving or obtaining may include the one or more transceivers 312, one or more antennas 314, and/or processing system 306 of the first network entity 300 or the second network entity 302 illustrated in FIG. 3, transceiver 1285, antenna 1290, and/or network interface 1295 of the communications device 1200 in FIG. 12, and/or one or more processors 1210 of the communications device 1200 in FIG. 12.

FIG. 13 depicts aspects of an example communications device 1300 configured for wireless communications. In some aspects, communications device 1300 is a distributed unit, which may be an example of (e.g., a functional component of) BS 102 of FIG. 1, a first network entity 300 or second network entity 302 of FIG. 3, or a disaggregated base station as discussed with respect to FIG. 2, as well as a distributed unit 804 of FIG. 8 and a distributed unit 904 of FIG. 9.

The communications device 1300 includes a processing system 1305 coupled to a transceiver 1345 (e.g., a transmitter and/or a receiver). The transceiver 1345 is configured to transmit and receive signals for the communications device 1300 via an antenna 1350, such as the various signals as described herein. The network interface 1355 is configured to obtain and send signals for the communications device 1300 via communications link(s), such as a midhaul link, and/or fronthaul link as described herein, such as with respect to FIG. 2. The processing system 1305 may be configured to perform processing functions for the communications device 1300, including processing signals received and/or to be transmitted by the communications device 1300.

The processing system 1305 includes one or more processors 1310 and a computer-readable medium/memory 1325. In various aspects, the one or more processors 1310 may be representative of the one or more processors 318 described with respect to FIG. 3. The one or more processors 1310 are coupled to a computer-readable medium/memory 1325 via a bus 1340. In some aspects, the computer-readable medium/memory 1325 may be representative of the one or more memories 320 described with respect to FIG. 3. The computer-readable medium/memory 1325 is a non-transitory computer-readable medium/memory. In certain aspects, the computer-readable medium/memory 1325 is configured to store instructions (e.g., computer-executable code), that when executed by the one or more processors 1310, cause the one or more processors 1310 to perform the method 1100 described with respect to FIG. 11, or any aspect related to it, including any operations described in relation to FIG. 11. Note that reference to a processor performing a function of communications device 1300 may include one or more processors performing that function of communications device 1300, such as in a distributed fashion.

In the depicted example, computer-readable medium/memory 1325 stores code (e.g., executable instructions), including code for obtaining 1330 and code for transmitting 1335. Processing of the code 1330 and 1335 may enable and cause the communications device 1300 to perform the method 1100 described with respect to FIG. 11, or any aspect related to it. For instance, in some aspects, code for obtaining 1330 includes code for obtaining, from a radio unit, an indication of a capability to support a RIM-RS measurement. In some aspects, code for transmitting 1335 includes code for transmitting, to the radio unit, a first configuration related to the RIM-RS measurement and a second configuration related to an RIM-RS measurement report. In some aspects, code for obtaining 1330 includes code for obtaining, from the radio unit, the RIM-RS measurement report in accordance with the second configuration, the RIM-RS measurement report based on the RIM-RS measurement performed in accordance with the first configuration.

The one or more processors 1310 include circuitry configured to implement (e.g., execute) the code stored in the computer-readable medium/memory 1325, including circuitry for obtaining 1315 and circuitry for transmitting 1320. Processing with circuitry 1315 and 1320 may enable and cause the communications device 1300 to perform the method 1100 described with respect to FIG. 11, or any aspect related to it. For instance, in some aspects, circuitry for obtaining 1315 includes circuitry for obtaining, from a radio unit, an indication of a capability to support a RIM-RS measurement. In some aspects, circuitry for transmitting 1320 includes circuitry for transmitting, to the radio unit, a first configuration related to the RIM-RS measurement and a second configuration related to an RIM-RS measurement report. In some aspects, circuitry for obtaining 1315 includes circuitry for obtaining, from the radio unit, the RIM-RS measurement report in accordance with the second configuration, the RIM-RS measurement report based on the RIM-RS measurement performed in accordance with the first configuration.

Various components of the communications device 1300 may provide means for performing the method 1100 described with respect to FIG. 11, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1345, antenna 1350, and/or network interface 1355 of the communications device 1300 in FIG. 13, and/or one or more processors 1310 of the communications device 1300 in FIG. 13. Means for communicating, receiving or obtaining may include the one or more transceivers 312, one or more antennas 314, and/or processing system 306 of the first network entity 300 or the second network entity 302 illustrated in FIG. 3, transceiver 1345, antenna 1350, and/or network interface 1355 of the communications device 1300 in FIG. 13, and/or one or more processors 1310 of the communications device 1300 in FIG. 13.

### Example Clauses

Implementation examples are described in the following numbered clauses:

Clause 1: A method for wireless communications by a radio unit comprising: transmitting, to a distributed unit, an indication of a capability to support a RIM-RS measurement; obtaining, from the distributed unit, a first configuration related to the RIM-RS measurement and a second configuration related to an RIM-RS measurement report; performing the RIM-RS measurement in accordance with the first configuration; and transmitting, to the distributed unit, the RIM-RS measurement report in accordance with the second configuration.

Clause 2: The method of Clause 1, wherein obtaining the first configuration and the second configuration comprises obtaining, using a control plane interface or a management plane interface, the first configuration and the second configuration.

Clause 3: The method of any one of Clauses 1-2, wherein transmitting the RIM-RS measurement report comprises transmitting, using a control plane interface or a user plane interface, the RIM-RS measurement report.

Clause 4: The method of any one of Clauses 1-3, further comprising obtaining a third configuration comprising an indication to resume or enter a network energy saving state after detecting an RIM-RS for the RIM-RS measurement.

Clause 5: The method of Clause 4, wherein obtaining the third configuration comprises obtaining, using a control plane interface or a management plane interface, the third configuration.

Clause 6: The method of Clause 4, wherein transmitting the RIM-RS measurement report comprises transmitting, using a control plane interface or a user plane interface, the RIM-RS measurement report.

Clause 7: The method of any one of Clauses 1-6, further comprising obtaining a third configuration related to a sub-sampling related to an RIM-RS for the RIM-RS measurement, the sub-sampling in at least one of a frequency dimension, a time dimension, or a space dimension, wherein the RIM-RS measurement report is based on the sub-sampling in accordance with the third configuration, the RIM-RS measurement report being based on the sub-sampling related to one or more RIM-RS specific parameters.

Clause 8: The method of any one of Clauses 1-7, further comprising obtaining a third configuration related to an I-Q sample collection for an RIM-RS for the RIM-RS measurement, wherein performing the RIM-RS measurement comprises performing the RIM-RS measurement, in accordance with the third configuration, using at least one of one or more receive endpoints or one or more carrier signals.

Clause 9: The method of any one of Clauses 1-8, wherein the capability comprises a capability, related to one or more receive endpoints, for processing one or more RIM-RSs via the one or more receive endpoints.

Clause 10: The method of any one of Clauses 1-9, wherein the capability comprises a capability, related to one or more receive endpoints, indicating a maximum number of RIM-RS time or frequency resources for processing.

Clause 11: The method of any one of Clauses 1-10, wherein transmitting the indication, obtaining the first configuration and the second configuration, and transmitting the RIM-RS measurement report comprises: transmitting the indication using a management plane interface; obtaining the first configuration and the second configuration using the management plane interface; and transmitting the RIM-RS measurement report using the management plane interface.

Clause 12: The method of Clause 11, wherein the capability indicates a measurement object type related to the RIM-RS measurement report.

Clause 13: The method of Clause 11, wherein the capability indicates a plurality of instances of a measurement object type related to the RIM-RS measurement report, wherein a number of the plurality of instances of the measurement object type is based on a number of configurations related to the RIM-RS measurement that the radio unit supports.

Clause 14: The method of Clause 11, further comprising: obtaining, from the distributed unit, another indication to start or stop receiving an RIM-RS; transmitting, to the distributed unit, a confirmation of obtaining the other indication; and starting or stopping receiving the RIM-RS in accordance with the other indication.

Clause 15: The method of any one of Clauses 1-14, wherein the capability indicates an endpoint support for: a ST-11 messaging type, and a total RIM-RS buffering capability.

Clause 16: The method of Clause 15, further comprising, using a control user synchronization plane interface: obtaining, from the distributed unit, an ST-11 message comprising a request to transmit the RIM-RS measurement report; and transmitting, to the distributed unit, a ST-10 message comprising the RIM-RS measurement report.

Clause 17: The method of any one of Clauses 1-16, further comprising: obtaining an RIM-RS from a network entity, wherein the RIM-RS measurement report is related to the network entity; and initiating an RIM procedure related to the network entity based on the RIM-RS measurement report.

Clause 18: The method of any one of Clauses 1-17, wherein the first configuration comprises a distributed unit-specific RIM-RS configuration comprising one or more of: a RIM-RS monitoring start time, a RIM-RS monitoring stop time, a RIM-RS monitoring window length, a RIM-RS monitoring window starting offset, a RIM-RS monitoring window periodicity, a RIM-RS monitoring occasion interval, or a RIM-RS monitoring occasion starting offset.

Clause 19: A method for wireless communications by a distributed unit comprising: obtaining, from a radio unit, an indication of a capability to support a RIM-RS measurement; transmitting, to the radio unit, a first configuration related to the RIM-RS measurement and a second configuration related to an RIM-RS measurement report; and obtaining, from the radio unit, the RIM-RS measurement report in accordance with the second configuration, the RIM-RS measurement report based on the RIM-RS measurement performed in accordance with the first configuration.

Clause 20: The method of Clause 19, wherein transmitting the first configuration and the second configuration comprises transmitting, using a control plane interface or a management plane interface, the first configuration and the second configuration.

Clause 21: The method of any one of Clauses 19-20, wherein obtaining the RIM-RS measurement report comprises obtaining, using a control plane interface or a user plane interface, the RIM-RS measurement report.

Clause 22: The method of any one of Clauses 19-21, further comprising transmitting a third configuration comprising an indication to resume or enter a network energy saving state after detecting an RIM-RS for the RIM-RS measurement.

Clause 23: The method of Clause 22, wherein transmitting the third configuration comprises transmitting, using a control plane interface or a management plane interface, the third configuration.

Clause 24: The method of Clause 22, wherein obtaining the RIM-RS measurement report comprises obtaining, using a control plane interface or a user plane interface, the RIM-RS measurement report.

Clause 25: The method of any one of Clauses 19-24, further comprising transmitting a third configuration related to a sub-sampling related to an RIM-RS for the RIM-RS measurement, the sub-sampling in at least one of a frequency dimension, a time dimension, or a space dimension, wherein the RIM-RS measurement report is based on the sub-sampling in accordance with the third configuration, the RIM-RS measurement report being based on the sub-sampling related to one or more RIM-RS specific parameters.

Clause 26: The method of any one of Clauses 19-25, further comprising transmitting a third configuration related to an I-Q sample collection for an RIM-RS for the RIM-RS measurement, wherein the RIM-RS measurement is performed, in accordance with the third configuration, using at least one of one or more receive endpoints or one or more carrier signals.

Clause 27: The method of any one of Clauses 19-26, wherein the capability comprises a capability, related to one or more receive endpoints, for processing one or more RIM-RSs via the one or more receive endpoints.

Clause 28: The method of any one of Clauses 19-27, wherein the capability comprises a capability, related to one or more receive endpoints, indicating a maximum number of RIM-RS time or frequency resources for processing.

Clause 29: The method of any one of Clauses 19-28, wherein obtaining the indication, transmitting the first configuration and the second configuration, and obtaining the RIM-RS measurement report comprises: obtaining the indication using a management plane interface; transmitting the first configuration and the second configuration using the management plane interface; and obtaining the RIM-RS measurement report using the management plane interface.

Clause 30: The method of Clause 29, wherein the capability indicates a measurement object type related to the RIM-RS measurement report.

Clause 31: The method of Clause 29, wherein the capability indicates a plurality of instances of a measurement object type related to the RIM-RS measurement report, wherein a number of the plurality of instances of the measurement object type is based on a number of configurations related to the RIM-RS measurement that the radio unit supports.

Clause 32: The method of Clause 29, further comprising: transmitting, to the radio unit, another indication to start or stop receiving an RIM-RS; and obtaining, from the radio unit, a confirmation of obtaining the other indication.

Clause 33: The method of any one of Clauses 19-32, wherein the capability indicates an endpoint support for: a ST-11 messaging type, and a total RIM-RS buffering capability.

Clause 34: The method of Clause 33, further comprising, using a control user synchronization plane interface: transmitting, to the radio unit, an ST-11 message comprising a request to transmit the RIM-RS measurement report; and obtaining, from the radio unit, an ST-10 message comprising the RIM-RS measurement report.

Clause 35: The method of any one of Clauses 19-34, wherein the first configuration comprises a distributed unit-specific RIM-RS configuration comprising one or more of: a RIM-RS monitoring start time, a RIM-RS monitoring stop time, a RIM-RS monitoring window length, a RIM-RS monitoring window starting offset, a RIM-RS monitoring window periodicity, a RIM-RS monitoring occasion interval, or a RIM-RS monitoring occasion starting offset.

Clause 36: One or more apparatuses, comprising: one or more memories comprising executable instructions; and one or more processors configured to execute the executable instructions and cause the one or more apparatuses to perform a method in accordance with any one of clauses 1-35.

Clause 37: One or more apparatuses configured for wireless communications, comprising: one or more memories; and one or more processors, coupled to the one or more memories, configured to cause the one or more apparatuses to perform a method in accordance with any one of Clauses 1-35.

Clause 38: One or more apparatuses configured for wireless communications, comprising: one or more memories; and one or more processors, coupled to the one or more memories, configured to perform a method in accordance with any one of Clauses 1-35.

Clause 39: One or more apparatuses, comprising means for performing a method in accordance with any one of Clauses 1-35.

Clause 40: One or more non-transitory computer-readable media comprising executable instructions that, when executed by one or more processors of one or more apparatuses, cause the one or more apparatuses to perform a method in accordance with any one of Clauses 1-35.

Clause 41: One or more computer program products embodied on one or more computer-readable storage media comprising code for performing a method in accordance with any one of Clauses 1-35.

Clause 42: A network entity, comprising: a processing system that includes processor circuitry and memory circuitry that stores code and is coupled with the processor circuitry, the processing system configured to cause the network entity to perform a method in accordance with any one of Clauses 1-35.

Clause 43: One or more apparatuses configured for wireless communications, comprising: a processing system that includes one or more processors and one or more memories coupled with the one or more processors, the processing system configured to cause the one or more apparatuses to perform a method in accordance with any one of Clauses 1-35.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus for wireless communications, comprising a processing system that includes one or more processors and one or more memories coupled with the one or more processors, the processing system configured to cause a radio unit to:
transmit, to a distributed unit, an indication of a capability to support a remote interference management reference signal (RIM-RS) measurement;
obtain, from the distributed unit, a first configuration related to the RIM-RS measurement and a second configuration related to an RIM-RS measurement report;
perform the RIM-RS measurement in accordance with the first configuration; and
transmit, to the distributed unit, the RIM-RS measurement report in accordance with the second configuration.

2. The apparatus of claim 1, wherein to cause the radio unit to obtain the first configuration and the second configuration, the processing system is configured to cause the radio unit to obtain, using a control plane interface or a management plane interface, the first configuration and the second configuration.

3. The apparatus of claim 1, wherein to cause the radio unit to transmit the RIM-RS measurement report, the processing system is configured to cause the radio unit to transmit, using a control plane interface or a user plane interface, the RIM-RS measurement report.

4. The apparatus of claim 1, wherein the processing system is further configured to cause the radio unit to obtain a third configuration comprising an indication to resume or enter a network energy saving state after detecting an RIM-RS for the RIM-RS measurement.

5. The apparatus of claim 4, wherein to cause the radio unit to obtain the third configuration, the processing system is configured to cause the radio unit to obtain, using a control plane interface or a management plane interface, the third configuration.

6. The apparatus of claim 4, wherein to cause the radio unit to transmit the RIM-RS measurement report, the processing system is configured to cause the radio unit to transmit, using a control plane interface or a user plane interface, the RIM-RS measurement report.

7. The apparatus of claim 1, wherein the processing system is further configured to cause the radio unit to obtain a third configuration related to a sub-sampling related to an RIM-RS for the RIM-RS measurement, the sub-sampling in at least one of a frequency dimension, a time dimension, or a space dimension,
wherein the RIM-RS measurement report is based on the sub-sampling in accordance with the third configuration, the RIM-RS measurement report being based on the sub-sampling related to one or more RIM-RS specific parameters.

8. The apparatus of claim 1, wherein the processing system is further configured to cause the radio unit to obtain a third configuration related to an in-phase and quadrature (I-Q) sample collection for an RIM-RS for the RIM-RS measurement,
wherein to cause the radio unit to perform the RIM-RS measurement, the processing system is configured to cause the radio unit to perform the RIM-RS measurement, in accordance with the third configuration, using at least one of one or more receive endpoints or one or more carrier signals.

9. The apparatus of claim 1, wherein the capability comprises a capability, related to one or more receive endpoints, for processing one or more RIM-RSs via the one or more receive endpoints.

10. The apparatus of claim 1, wherein the capability comprises a capability, related to one or more receive endpoints, indicating a maximum number of RIM-RS time or frequency resources for processing.

11. The apparatus of claim 1, wherein to cause the radio unit to transmit the indication, obtain the first configuration and the second configuration, and transmit the RIM-RS measurement report, the processing system is configured to cause the radio unit to:
transmit the indication using a management plane interface;
obtain the first configuration and the second configuration using the management plane interface; and
transmit the RIM-RS measurement report using the management plane interface.

12. The apparatus of claim 11, wherein the capability indicates a measurement object type related to the RIM-RS measurement report.

13. The apparatus of claim 11, wherein the capability indicates a plurality of instances of a measurement object type related to the RIM-RS measurement report, wherein a number of the plurality of instances of the measurement object type is based on a number of configurations related to the RIM-RS measurement that the radio unit supports.

14. The apparatus of claim 11, wherein the processing system is further configured to cause the radio unit to:
obtain, from the distributed unit, another indication to start or stop receiving an RIM-RS;
transmit, to the distributed unit, a confirmation of obtaining the other indication; and
start or stop receiving the RIM-RS in accordance with the other indication.

15. The apparatus of claim 1, wherein the capability indicates an endpoint support for:
a Section Type 11 (ST-11) messaging type, and
a total RIM-RS buffering capability.

16. The apparatus of claim 15, wherein the processing system is further configured to cause the radio unit to, using a control user synchronization plane interface:
obtain, from the distributed unit, an ST-11 message comprising a request to transmit the RIM-RS measurement report; and
transmit, to the distributed unit, a Section Type 10 (ST-10) message comprising the RIM-RS measurement report.

17. The apparatus of claim 1, wherein the processing system is further configured to cause the radio unit to:
obtain an RIM-RS from a network entity, wherein the RIM-RS measurement report is related to the network entity; and
based on the RIM-RS measurement report, initiate an RIM procedure related to the network entity.

18. The apparatus of claim 1, wherein the first configuration comprises a distributed unit-specific RIM-RS configuration comprising one or more of:
a RIM-RS monitoring start time,
a RIM-RS monitoring stop time,
a RIM-RS monitoring window length,
a RIM-RS monitoring window starting offset,
a RIM-RS monitoring window periodicity,
a RIM-RS monitoring occasion interval, or
a RIM-RS monitoring occasion starting offset.

19. A method for wireless communications by a radio unit comprising:
transmitting, to a distributed unit, an indication of a capability to support a remote interference management reference signal (RIM-RS) measurement;
obtaining, from the distributed unit, a first configuration related to the RIM-RS measurement and a second configuration related to an RIM-RS measurement report;
performing the RIM-RS measurement in accordance with the first configuration; and
transmitting, to the distributed unit, the RIM-RS measurement report in accordance with the second configuration.

20. A method for wireless communications by a distributed unit comprising:
obtaining, from a radio unit, an indication of a capability to support a remote interference management reference signal (RIM-RS) measurement;
transmitting, to the radio unit, a first configuration related to the RIM-RS measurement and a second configuration related to an RIM-RS measurement report; and
obtaining, from the radio unit, the RIM-RS measurement report in accordance with the second configuration, the RIM-RS measurement report based on the RIM-RS measurement performed in accordance with the first configuration.
